(19) United States
(12) Patent Application Publication
(10) Pub. No.: US 2024/0380682 A1
(43) Pub. Date: Nov. 14, 2024

(54) MANAGING MULTICAST STATISICAL INFORMATION FOR CONTAINERS IN A COMPUTING NETWORK

(71) Applicant: VMware LLC, Palo Alto, CA (US)

(72) Inventors: Ruochen Shen, Beijing (CN); Wenying Dong, Beijing (CN); Bin Liu, Beijing (CN); Quan Tian, Beijing (CN); Jianjun Shen, Redwood City, CA (US)

(21) Appl. No.: 18/315,599

(22) Filed: May 11, 2023

(30) Foreign Application Priority Data
Jan. 18, 2023 (WO) PCT/CN2023/000015

(51) Int. Cl. H04L 43/0876; H04L 12/18

(52) U.S. Cl. CPC H04L 43/0876; H04L 12/1863

(57) ABSTRACT

Described herein are systems, methods, and software to manage statistical information associated with multicast communications for containers in a computing network. In one example, a management service receives multicast statistical information from nodes deployed in a computing network. The management service aggregates the multicast statistical information from the nodes and, in response to a summary request, generates a summary for display based on the aggregated multicast statistical information.

### RELATED APPLICATIONS

This application claims benefit from and priority to PCT Application Serial No. PCT/CN2023/000015 filed in China entitled “MANAGING MULTICAST STATISTICAL INFORMATION FOR CONTAINERS IN A COMPUTING NETWORK”, on Jan. 18, 2023, which is herein incorporated in its entirety by reference for all purposes.

### BACKGROUND

In computing environments, virtual switches may be used that comprise software modules capable of providing a communication platform for one or more virtual nodes (virtual machines, containers, and the like) in the computing environment. These virtual switches may be used to intelligently direct communications on the network by inspecting packets before passing them to other nodes on the same network. For example, packets may be inspected to determine the source and destination internet protocol (IP) addresses to determine if the communication is permitted to be delivered to a destination. In some implementations, virtual switches may be configured with forwarding rules or flow operations that indicate actions to be taken against a packet. These flow operations identify specific attributes, such as IP addresses, media access control (MAC) addresses, and the like within the data packet and, when identified, provide a set of actions to be asserted against the data packet. These actions may include modifications to the data packet, forwarding rules for the data packet, amongst other possible operations.

In some computing environments, nodes, physical or virtual, can be used to support container groups (e.g., Kubernetes™ pods or Azure™ container groups), wherein each container group includes one or more containers and a specification how to run the one or more containers. The container groups can be coupled to a virtual switch using a veth pair that acts as a tunnel between network namespaces, such as the container namespace for the container group and the node namespace. These interfaces can be used to receive network traffic directed to a unique address associated with a container group or receive multicast traffic that can be requested by multiple container groups. However, while multicast traffic can be directed to a container group, difficulties can arise in monitoring and quantifying the multicast traffic in a containerized environment.

### OVERVIEW

The technology disclosed herein manages multicast statistical information for containers in a computing network according to an implementation. In one implementation, a method of operating a management service for a computing network includes receiving multicast statistical information from nodes in a computing environment, wherein the multicast statistical information comprises quantities of ingress and egress multicast packets associated with container groups on the nodes. The method further includes aggregating the multicast statistical information from the nodes and, in response to a summary request, generating a summary for display based on the aggregated multicast statistical information.

### BRIEF DESCRIPTION OF THE DRAWINGS

FIG. 1 illustrates a computing network to manage multicast statistical information for containers in a computing network.

FIG. 2 illustrates a method of operating a virtual switch to monitor multicast traffic for container groups in a computing network according to an implementation.

FIG. 3 illustrates a method of operating a management service for a computing network to compile multicast statistical information and generate summaries based on the information according to an implementation.

FIG. 4 illustrates an operational scenario of monitoring network traffic in nodes to identify multicast statistical information according to an implementation.

FIG. 5 illustrates an operational scenario of generating a statistical summary associated with multicast communications according to an implementation.

FIG. 6 illustrates a management service computing system to aggregate multicast statistical information for a computing network and generate summaries according to an implementation.

### DETAILED DESCRIPTION

In computing networks, nodes, which can comprise physical computers or virtual machines, are deployed that can provide a platform for the execution of container groups (e.g., Kubernetes™ Pods or Azure™ container groups). Container groups are a group of one or more containers with shared storage and network resources, and a specification for how to run the containers in the container groups. These container groups can execute in different namespaces that are used to separate the resources available to a first container group (networking, storage, and the like) from resources available to a second container group. On a node, a container group connects to a virtual switch using a veth pair that acts as a tunnel between the namespace associated with the virtual switch and the namespace for the container group.

Here, container groups can register to receive multicast communications associated with different multicast groups or can be configured via an administrator to permit or block multicast communications associated with one or more groups. As a first example, a container group can generate a packet to register packets in a first multicast group. Once registered, packets with a destination multicast address for the first multicast group can be forwarded to the container group. In an alternative example, an administrator can generate rules that permit, block, drop or perform other operations on multicast packets directed at the different container groups. A rule can permit multicast packets associated with a first multicast group to a first set of container groups, while blocking multicast packets associated with the first multicast group to a second set of container groups.

In some implementations, agents at the nodes of the computing network can monitor traffic associated with multicast packets and communicate summarized information to a management service that can aggregate the information from different nodes. The monitored network traffic can indicate container groups that are registered in association with each multicast group, the quantity of multicast packets sent or received in association with each container group or multicast group, the number of packets permitted, blocked, dropped, or otherwise acted on in association with a rule for multicast traffic, or some other information for the multicast traffic at each of the nodes. The management service can then generate a summary of the aggregated information from the nodes, including the container groups that are registered with each multicast group, the amount of traffic associated with each multicast group, the amount of multicast traffic (sent, received, dropped, etc.) associated with each container group, or some other information. In some implementations, the summary can be generated at the request of an administrator, however, the summary can be generated with the aggregated information satisfies one or more criteria. The criteria can include a threshold quantity of container groups joining a multicast group, a threshold quantity of packets sent or received in association with a multicast group, a threshold quantity of packets sent, received, blocked, or dropped in association with a container group, or some other criteria. The summary can be provided as text or as part of a chart and can promote portions of the statistics that satisfy one or more criteria. As an example, information about a first multicast group can be promoted over one or more other multicast groups when the number of container group members, the amount of traffic, or some other metric satisfies one or more criteria.

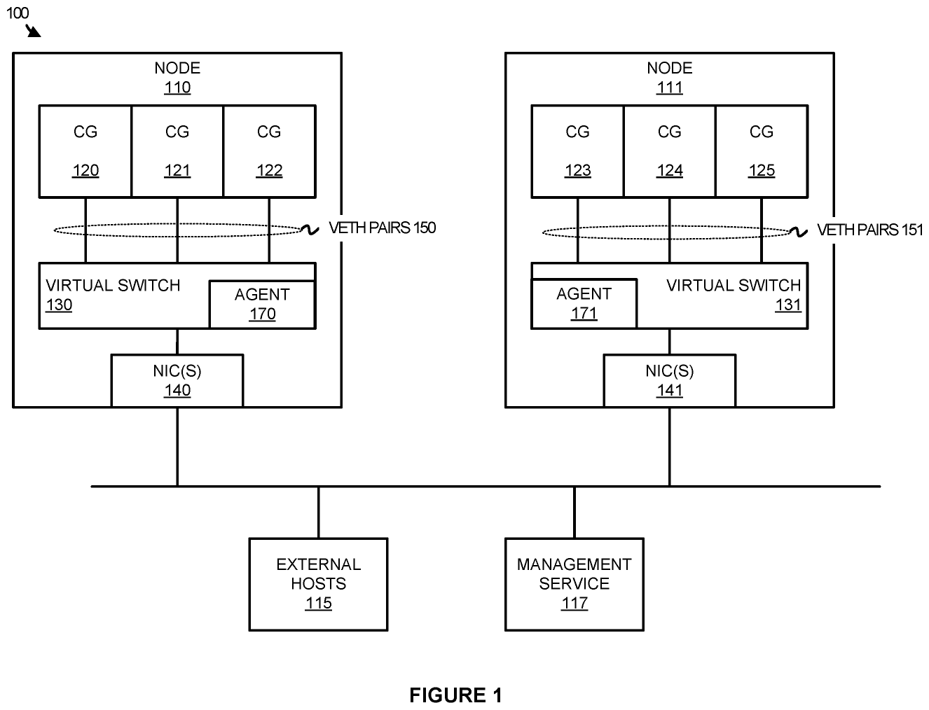

FIG. 1 illustrates a computing network 100 to manage multicast statistical information for containers in a computing network. Computing network 100 includes nodes 110-111, external hosts 115, and management service 117. Nodes 110-111 can comprise physical computers or virtual machines capable of acting as a platform for container groups 120-125 (“CGs”), virtual switches 130-131, and agents 170-171. Nodes 110-111 further include network interfaces (“NIC(S)”) 140-141, wherein network interfaces 140-141 can comprise physical interfaces or virtual interfaces in some examples. External hosts 115 can comprise physical computers capable of receiving or sending multicast communications. Although demonstrated with two nodes in the example of computing network 100, any number of nodes can be deployed in a computing network.

In computing network 100, container groups 120-125 each comprise one or more containers (not shown) that are coupled to virtual switches 130-131 using veth pairs 150-151. The containers each comprise a standalone, executable package that includes elements required to execute an application, including code, runtime, system tools, system libraries, settings, and the like. The containers can be separated on nodes 110-111 using namespaces that can isolate the resources that are provided to the various containers or container groups. For example, container group 120 can be allocated first resources that are associated with a first namespace, while container group 121 can be allocated second resources that are associated with a different namespace.

To support the communications for each of container groups 120-125, veth pairs 150-151 are used, wherein the veth pairs act as a tunnel between the namespace associated with virtual switches 130-131 and the namespace associated with the corresponding container group. For example, a first veth pair is used to support container group 120, while a second veth pair is used to support container group 121 on node 110. Each veth pair can be associated with an IP that differentiates ingress and egress packets for a first container group from ingress and egress packets for a second container group. For example, container group 120 can be associated with the IP address 10.1.1.2/24, while container group 121 can be associated with IP address 10.1.1.3/24. Packets can be forwarded by virtual switches to an interface (i.e., virtual network interface for a veth pair) associated with the container groups based on the destination address in the packet. Virtual switches can also provide further operations including firewall operations, whitelist operations, or other similar operations on identified packets. Virtual switches 130-131 can perform packet processing, such as multicast forwarding operations, for packets sent between container groups located on the same node (i.e., host for the container groups), between container groups on different nodes, or between container groups and external hosts 115 or other computing systems.

Here, one or more container groups in computing network 100 can be configured to receive packets associated with a multicast IP address, wherein a multicast communication can be forwarded to multiple destination computing elements, including virtualized endpoints (containers, virtual machines, and the like) and physical computing systems. This configuration can be based on a manual configuration of the corresponding virtual switch or can be configured based on a request from a container group to receive packets directed at a multicast IP address.

In registering with either of virtual switches 130-131, an agent of agents 170-171 can identify the registration for the container group and configure the local node to forward packets with the destination multicast IP address to the registered container group. The registration packet from the container group can comprise an Internet Group Management Protocol (IGMP) packet, a Multicast Listener Discovery (MLD) packet, or some other multicast registration packet that can identify the registration from the container group. In at least one example, IGMP packets are used for a cluster of container groups that use IPv4 addressing, while MLD packets are used for a cluster of container groups that use IPv6 addressing. Configuring the node may include configuring one or more forwarding rules for forwarding packets with the multicast IP address from a network interface of the node to the registered container group or may include configuring one or more forwarding rules for forwarding packets from other container groups on the same node with the multicast IP address to the destination container group.

For example, when container group 125 registers with agent 171 with a first multicast IP address, agent 171 can generate one or more forwarding rules to forward packets with the first multicast IP address to container group 125. In some examples, node 111 can advertise to neighboring devices, such as routers (not shown) indicating the registration of the first multicast IP address. This permits the neighboring devices to forward packets with the first multicast IP address as the destination address to network interface(s) 141 of node 111. Once received, virtual switch 131 can process the packets in accordance with the one or more forwarding rules to forward the packets to the virtual interface for container group 125. Similarly, if a packet is generated with the first multicast IP address as a destination IP address from container group 123, virtual switch 131 can identify the packet at the virtual interface for container group 123 (e.g., interface for the veth pair of container group 123 at virtual switch 131) and process the packet in accordance with the one or more forwarding rules generated in response to the registration from container group 125. The one or more rules can forward the packet locally to container group 125.

Here, in addition to managing the forwarding rules associated with multicast packets, each node of nodes 110-111 can use agents 170-171 to monitor traffic associated with container groups 120-125 and identify multicast packets in the traffic. The multicast packets can comprise egress packets communicated out of a container group or ingress packets directed to a container group. The monitoring can include packet inspection to identify multicast destination IP addresses, identify registration packets from container groups, identify when multicast rules are triggered based on addressing in the packets, or based on some other monitoring of the traffic at the nodes. From the monitored traffic, agents 170-171 can compile multicast statistical information for each of the container groups. The multicast statistical information can include the quantity of multicast packets communicated out of each of the container groups, the quantity of multicast packets communicated to each of the container groups, the quantity of data sent or received in multicast packets by each of the container groups, or some other multicast statistical information for each of the container groups. The multicast statistical information can further include statistics associated with each multicast group, wherein a multicast group comprises one or more container groups (or other devices in the network) registered to receive packets with a particular multicast IP address. The statistical information associated with the multicast group can include identifiers for the container groups that have registered for the group, the number of packets sent or received in association with the group, the quantity of container groups that have joined the group, or some other information associated with the multicast group.

In some examples, the multicast statistical information can be generated when specific forwarding rules are triggered in a virtual switch. For example, if container group 122 registered to receive multicast packets directed to a first destination multicast IP address, a forwarding rule can be added to virtual switch 130 to provide packets with the multicast IP address to container group 122. When a packet is received at NIC(s) 140 or identified from another container group of container groups 120-121 with the multicast IP address as the destination IP address, the rule can be applied to forward the packet to the veth pair for container group 122. Additionally, when the forwarding rule applies in association with the packet, agent 170 can update multicast statistical information based on triggering the rule. The multicast statistical information can indicate the quantity of multicast packets received by each of the container groups, the quantity of multicast packets communicated by each of the container groups, the multicast IP address or multicast group associated with the packets, or some other statistical information. In some examples, the multicast statistical information can further identify the quantity of multicast packets that are blocked or prevented from being communicated to container groups within the computing network.

As the multicast statistical information is monitored and compiled at each of the nodes in computing network 100, the multicast statistical information is communicated to management service 117. Management service 117 may execute across one or more computers and may operate at least partially on the same computers as nodes 110-111. As the multicast statistical information, management service 117 can aggregate the statistical information and generate summaries that can be provided to an administrator of computing network 100. The aggregated multicast statistical information can indicate quantities of ingress and egress multicast packets to each of container groups 120-125, can indicate member container groups of each multicast group, can indicate the quantity of ingress and egress packets associated with each multicast group, can indicate quantities of multicast packets that were dropped or blocked based on forwarding rules at each of the nodes, or can provide any other statistical information regarding the multicast packets in the computing network 100.

As an example, nodes 110-111 can communicate multicast statistical information to management service 117 that indicates that container groups 122 and 125 have joined the same multicast group. In joining the group, container groups 122 and 125 may each communicate an IGMP or MLD packet that is identified by the corresponding virtual switch of virtual switches 130-131. Once identified, virtual switches 130-131 apply forwarding rules to communicate packets with a destination IP address for the multicast group to container groups 122 and 125. After configuring the rules, agents 170-171 monitor network traffic in association with the container groups and identify packets associated with the multicast group. Thus, agent 170 can identify packets with the multicast IP address associated with the multicast group that are directed to container group 122 and quantify the amount of traffic associated with the multicast group. Node 110 then communicates the statistical information associated with the multicast group to management service 117, wherein the information can be supplied periodically, at the request of management service 117, during a network downtime or resource usage satisfying one or more criteria, or at some other interval. Management service 117 can compile the multicast statistical information from node 110 with the information provided by node 111 to generate a summary of the multicast traffic in the network. Thus, if an administrator of computing network 100 requested statistical information associated with the multicast group with container groups 122 and 125, management service 117 can generate a summary for display that includes the relevant statistical information. The summary can indicate the different container groups that joined the multicast group, the number of packets received by each of the container groups in the multicast group, or some other information associated with the multicast group.

In some implementations, the summary can prioritize statistics that satisfy one or more criteria. The criteria can include multicast group members exceeding a threshold, multicast traffic associated with a multicast group exceeding a threshold, traffic associated with a particular container group exceeding a threshold, traffic associated with a particular multicast rule exceeding a threshold, or some other criteria. The statistics that satisfy the criteria can be promoted into a higher location of the summary, can be highlighted, or promoted in some other means in relation to the other statistics. As an example, if the multicast traffic associated with a first container group exceeded a threshold, one or more statistics associated with the first container group can be promoted over statistics associated with other multicast groups. Alternatively, individual statistics that satisfy criteria (e.g., incoming multicast packets to a multicast group) can be promoted over other statistics.

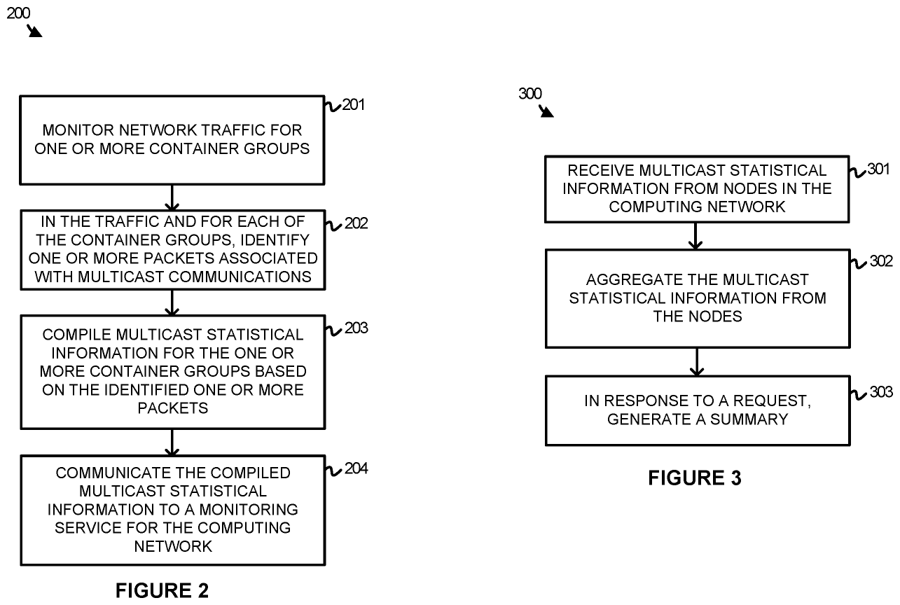

FIG. 2 illustrates a method 200 of operating a virtual switch to monitor multicast traffic for container groups in a computing network according to an implementation. The steps of method 200 are referenced parenthetically in the paragraphs that follow with reference to systems and elements of computing network 100 of FIG. 1. Although provided below using the example of node 110, similar operation can be performed by node 111 in providing multicast statistical information to management service 117.

Method 200 includes monitoring (201) network traffic associated with one or more container groups on the node with the virtual switch and, for each of the container groups, identifying (202) one or more packets associated with multicast communications. Virtual switches can be configured with various rules that are used in providing routing operations, firewall operations, encapsulation operations, and the like. These rules can be used to direct packets to different interfaces based on attributes (IP addresses, MAC addresses, protocols, etc.). Here, container groups are registered or associated with various multicast groups, wherein each group of one or more container groups can receive packets with a corresponding multicast address. For example, container groups 120-121 can register with a first multicast group associated with a first multicast IP address, while container group 122 can register with a second multicast group associated with a second multicast IP address. After registration, packets with the corresponding destination IP address can be forwarded to the corresponding container group. In some examples, the container groups can register for a multicast group using IGMP or MLD, wherein following registration for the group, packets can be communicated to the registering container group with the multicast IP address associated with the group.

After the container groups are registered to one or more groups, agent 170 can monitor the network traffic to determine when multicast packets are sent from or directed to a particular container group. For example, agent 170 can monitor when forwarding rules associated with multicast packets are triggered to identify the corresponding packet. Accordingly, if a multicast packet were received at NIC(s) 140 and a forwarding rule is triggered to forward the packet to container group 122, agent 170 can identify the packet as an ingress multicast packet for container group 122.

As the packets are identified for the various container groups on node 110, method 200 further includes compiling (203) multicast statistical information for the one or more container groups based on the identified one or more packets. The multicast statistical information can include the quantity of ingress multicast packets for each of the container groups, the quantity of egress multicast packets for each of the container groups, quantities of blocked or dropped multicast packets at the node, or some other statistical information about the multicast communications at the node. In some examples, the multicast statistical information can indicate container groups that are members of each multicast group, the quantity of packets received or sent in association with each multicast group, or some other information associated with each multicast group. In identifying the statistical information associated with each of the groups, agent 170 can identify registration packets (IGMP or MLD) and maintain a record of the multicast groups registered for each of the container groups. Agent 170 can further monitor when container groups expressly remove themselves from a multicast group or timeout of a multicast group, and such indication can be included as part of the multicast statistical information. For example, while container group 120 may initially register for a first multicast group, the registration can expire if container group 120 does not reregister or keep alive the registration for the first multicast group.

Once the multicast statistical information is compiled, method 200 includes communicating (204) the compiled multicast statistical information to a management service for the computing network. The compiled information can be communicated periodically to the management service, can be communicated at the request of the management service, can be communicated during low resource usage periods (low CPU, networking, etc.), or can be communicated at some other interval.

In some implementations, an administrator of the computing network can define rules that permit or block multicast communications to and from container groups on the hosts. In at least one example, an administrator can block all multicast packets directed to a particular container group or can block communications directed to a specific multicast IP address from being received by a container group. These rules, which are implemented as part of the hypervisor, can log when hits occur in association with the rules. For example, a rule that blocks packets with a first multicast IP address from being directed to container group 125 can be triggered when a packet is identified with the first multicast IP address. Once triggered, a counter can be updated in association with the rule. Similar counters can be maintained for rules that permit or direct packets with a multicast address to a container group in the computing network. The statistics for the rules can be compiled and provided to the management service. Advantageously, statistical information can be maintained in association with container groups registering for multicast communications and for manually defined rules for multicast packets in the computing network.

FIG. 3 illustrates a method 300 of operating a management service for a computing network to compile multicast statistical information and generate summaries based on the information according to an implementation. The steps of operation 300 are referenced parenthetically in the paragraphs that follow with reference to systems and elements of computing network 100 of FIG. 1. Although demonstrated with two nodes in the example of computing network 100, a computing network can deploy any number of nodes to support container groups and operations.

Method 300 includes receiving (301) multicast statistical information from nodes in the computing network. The statistical information can include quantities of ingress and egress multicast packets for the container groups on the nodes, identifiers for container groups that are members of each multicast group, quantities of packets sent and received in association with each of the multicast groups, quantities of packets dropped in association with multicast groups (e.g., blocked via firewall or other forwarding rules), or some other multicast statistical information. The information can be received periodically from the nodes, can be obtained via request from management service 117, or can be received at some other interval. For example, nodes 110-111 could communicate the statistical information to management service 117 at periodic intervals.

As the multicast statistical information is received, method 300 further provides for aggregating (302) the multicast statistical information from the nodes. The aggregation can include aggregating the number of packets received by each of the multicast groups, aggregating or identifying the different container groups that are registered in association with each of the multicast groups, or providing some other aggregation of the statistics from the nodes of computing network 100. Once the numbers are aggregated, method 300 further includes, in response to a request, generating (303) a summary to provide at least a portion of the statistical information for the administrator of the computing network. The summary can be provided as a table, list, chart, graph, or some other visual display of at least a portion of the statistical information. The request can indicate one or more container groups of interest, one or more multicast groups of interest, or some other preference. In response to the request, management service 117 can identify portions of the aggregated multicast statistical information based on the preferences and provide a response to the administrator. For example, the administrator can generate a request to list or identify all container groups that are registered in association with a first multicast group. In response to the request, management service 117 will generate a summary that indicates the one or more container groups registered with the group, wherein the one or more container groups can be distributed across multiple nodes.

Although demonstrated as generating the summary in response to a request, a summary can be generated based on other triggering events or criteria. The other triggering events or criteria can include a quantity of multicast packets being received by a container group or a multicast group, a quantity of container groups joining a multicast group, or some other triggering event. The summary can be provided as part of an email, a web interface, a text, or some other summary mechanism.

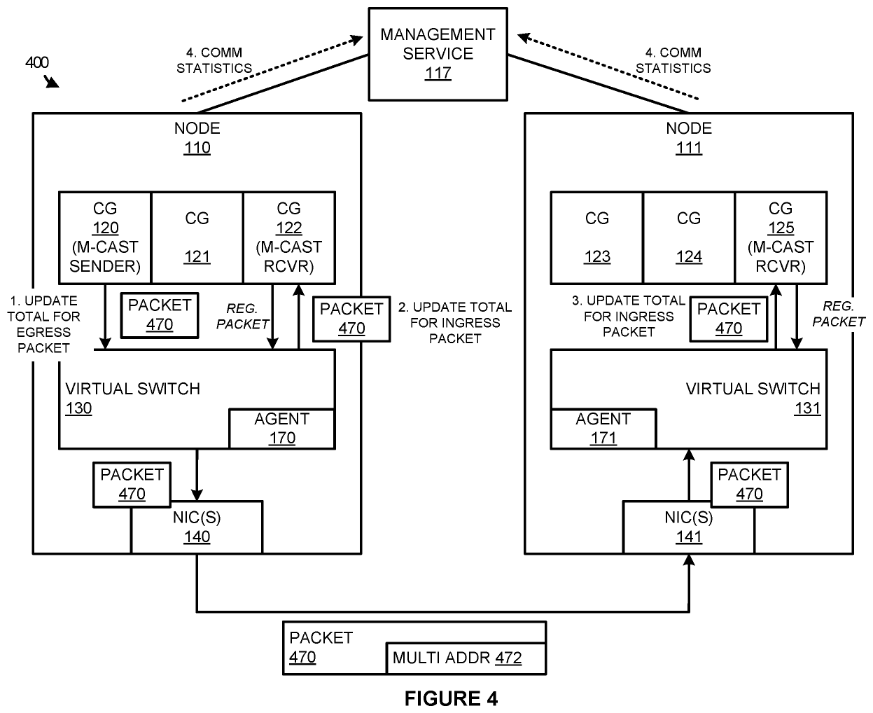

FIG. 4 illustrates an operational scenario 400 of monitoring network traffic in nodes to identify multicast statistical information according to an implementation. Operational scenario 400 includes nodes 110-111 and management service 117 of computing network 100 of FIG. 1. Operational scenario 400 further includes packet 470 with multicast address 472.

In operational scenario container groups 122 and 125 are registered to receive multicast packets with a multicast address 472. In registering the container groups, the container groups can generate IGMP or MLD packets that indicate a multicast address for receiving multicast communications. In response to the request and if the registration is permitted, forwarding rules can be applied in virtual switches 130-131 to direct multicast packets to the registered container group. Additionally, NIC(s) of nodes 110-111 can be configured to advertise and receive packets associated with the multicast communication.

After container groups are registered to receive packets, container group 120 can generate packet 470 with multicast address 472. Virtual switch 130 will identify the packet from container group 120 and update a total for egress multicast packets based on identifying the packets at step 1. The total can be increased when at least one forwarding rule is triggered in association with the egress multicast packet. Additionally, virtual switch 130 can direct packet 470 to the interface associated with container group 122, wherein virtual switch 130 can increase at least one total associated with ingress multicast packets at step 2 for container group 122.

In addition to forwarding packet 470 to a local container group of node 110, node 110 further communicates packet 470 to node 111, wherein node 111 can process packet 470 and communicate the packet to container group 125 based on the forwarding rules and registration for container group 125. Additionally, virtual switch 131 and agent 171 can update a total associated with ingress multicast packets at step 3. The increase can be triggered when one or more forwarding rules are triggered in association with a multicast destination IP address. As the totals or quantities are maintained for the container groups at each node of nodes 110-111, nodes 110-111 can communicate multicast statistic information to management service 117 at step 4. The multicast statistic information can indicate the container groups registered for each multicast group, the quantity of multicast packets received by each container group, the quantity of packets associated with each multicast group received by each container group, the quantity of multicast packets sent, or some other information associated with ingress and egress multicast packets. In some implementations, the information can further include information about the multicast packets that are permitted and blocked/dropped in association with the various container groups. For example, a forwarding rule can prevent multicast packets for a first group from being communicated to container group 121, even when container group 121 registers to receive the packets for the first group. Accordingly, when virtual switch 130 applies the forwarding rule, agent 170 can increase a total in association with packets dropped by the rule.

After the multicast statistical information is provided to management service 117, management service 117 can aggregate the statistics from all the nodes in the computing network 100 and use the aggregated statistics to generate a summary for an administrator. The aggregated statistics and summary can indicate the container groups that belong to one or more of the multicast groups, the quantity of ingress and egress packets received by container groups in the multicast groups, the quantity of multicast packets sent or received by each of the container groups, or some other information in association with the aggregated statistics. The summary can be generated by the request of an administrator for computing network 100 or can be generated when the aggregated multicast statistic information satisfies one or more criteria. As an example, an administrator may request identifiers associated with all container groups in a first multicast group. In response to the request, management service 117 can identify the container groups in the corresponding group and provide the identifiers for the container groups as part of the summary. The identifiers can comprise unique identifiers, IP addresses, or some other information to identify the container groups. The summary can further indicate the node on which each of the container groups is executing.

In some implementations, the summary can promote multicast groups, container groups, or specific statistics from the aggregated statistical information that satisfy one or more criteria. The promoted information can be placed higher in the summary, highlighted, provided in a different font, or promoted in some other manner in relation to the other information in the summary. As an illustrated example, a first multicast group may receive a quantity of multicast packets that exceed a threshold. The summary can promote one or more multicast statistics (e.g., membership information, packets received, etc.) in relation to other multicast statistical information

Although demonstrated using statistical information for container groups that register for multicast groups, multicast statistical information associated with rules can be maintained in addition to, or in place of, the registered statistical information. An administrator can define the rules for the container groups in the computing network, wherein the rules can permit egress or ingress multicast communications for container groups, block egress or ingress multicast communications for container groups, or provide some other rule in association with forwarding packets for container groups in a computing network. When a rule is triggered at a node, a log is updated by the node to indicate statistical information associated with the triggered rule (packets, total data, etc.). The information can then be provided as the compiled statistical information to the management service and used in providing the summary for the computing network.

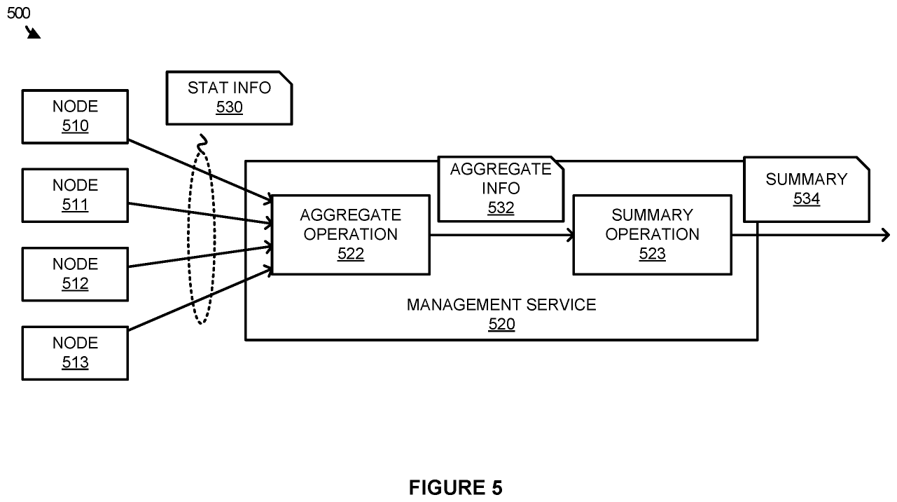

FIG. 5 illustrates an operational scenario 500 of generating a statistical summary associated with multicast communications according to an implementation. Operational scenario 500 includes nodes 510-513, management service 520, multicast statistic information 520, aggregated multicast statistic information 532, and summary 534. Management service 520 further provides aggregate operation 522 and summary operation 523.

In operational scenario 500, nodes 510-513 identify multicast statistic information associated with container groups executing thereon. The information can be gathered from monitoring multicast packets communicated in the data plane in association with the container groups and can further be gathered from IGMP or MLD packets that are used by the container groups to register for a multicast group. The multicast statistic information can include quantities of multicast packets communicated by the container groups, registrations of container groups to the multicast groups, or some other information. As the information is gathered, the multicast statistical information 530 is communicated by the nodes to management service 520. Management service 520 performs aggregate operation 522 to generated multicast aggregate information 532. Multicast aggregate information 532 can indicate the container groups that have joined each multicast group (and node locations), can indicate quantities of ingress and egress multicast packets for each of the container groups, can indicate quantities of packets sent or received in association with each of the multicast groups, or can comprise some other aggregated information associated with multicast traffic at the various nodes. As an example, each of the nodes can monitor for IGMP or MLD packets from container groups to register with a multicast group. The nodes can then provide identifiers for the various container groups that have registered with each of the groups to management service 117 and management service 117 can identify the container groups that belong to a multicast group across the plurality of nodes in the computing network. The summary can then indicate the members of at least one multicast group in a summary that is presented to an administrator of the computing environment.

In some implementations, the statistical information 530 can include statistics associated with administrator defined rules. The rules can be used to block multicast packets to container groups, permit multicast packets to container groups, drop, or log multicast packets, or provide some other action in association with multicast packets. When a rule is triggered in the virtual switch, an update is made to a log in association with rule, wherein the log can indicate the number of packets affected by the rule, the amount of data affected by the rule, or some other information associated with the rule. The information can then be supplied to management service 520 with the statistical information identified from the registered container groups or in place of the information from the registered container groups. Advantageously, management service 520 can receive statistical information associated with manually configured multicast rules in addition to, or in place of, the statistics associated with registered container groups to multicast groups.

Although demonstrated as querying a management service for the computing network to obtain the multicast statistical information, an administrator can query the individual nodes to retrieve information about individual nodes. The information can include packet count information for multicast packets received or sent by the different container groups, membership information for multicast groups, or some other information associated with multicast statistics for the node.

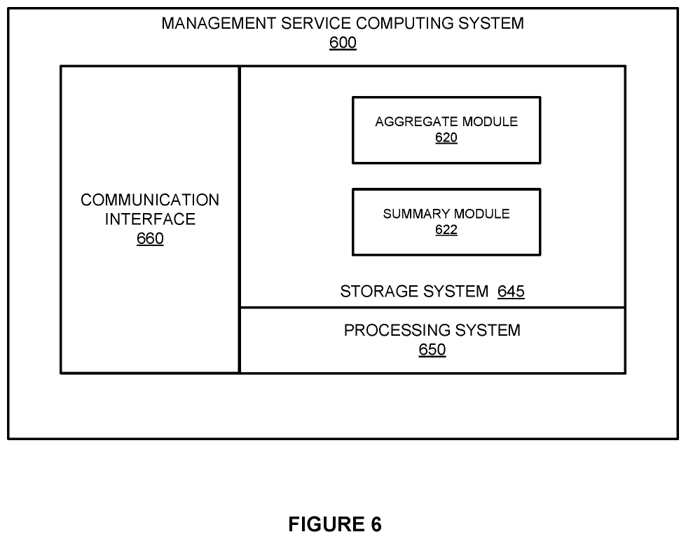

FIG. 6 illustrates a management service computing system 600 to aggregate multicast statistical information for a computing network and generate summaries according to an implementation. Management computing system 600 is representative of any computing system or systems with which the various operational architectures, processes, scenarios, and sequences disclosed herein for a management service can be implemented. Management computing system 600 is an example of management service 117 of FIG. 1, although other examples may exist. Management computing system 600 includes storage system 645, processing system 650, and communication interface 660. Processing system 650 is operatively linked to communication interface 660 and storage system 645. Communication interface 660 may be communicatively linked to storage system 645 in some implementations. Management computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 may be configured to communicate with nodes of a computing system, servers, administrative or console devices, or some other computing device.

Processing system 650 comprises microprocessor and other circuitry that retrieves and executes operating software from storage system 645. Storage system 645 may include volatile and nonvolatile, removable, and non-removable media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises aggregate module 620 and summary module 622. The operating software on storage system 645 may further include an operating system, utilities, drivers, network interfaces, applications, or some other type of software. When read and executed by processing system 650 the operating software on storage system 645 directs management computing system 600 to operate as a management service described herein in FIG. 1-5.

In at least one implementation, aggregate module 620 directs processing system 650 to receive multicast statistical information from nodes of a computing network, wherein the nodes can comprise physical computers or virtual machines executing on physical hosts. Each of the nodes can identify container groups that register for each multicast group, can identify quantities of multicast packets sent and received by each of the container groups, the multicast groups associated with each of the multicast packets sent and received, or some other multicast statistical information associated with the container groups. The information can be determined from registration packets from the container groups (IGMP or MLD packets) and data path packets that can include the multicast traffic. As the information is identified for the container groups, each of the nodes in the computing network can communicate the multicast statistical information to management service computing system 600. The information can be communicated periodically, at the request of management service computing system 600, when the resource usage associated with the nodes satisfies one or more criteria (e.g., low CPU or networking usage), or at some other interval.

As the information is received from the nodes in the computing network, aggregate module 620 directs processing system 650 to aggregate the data, wherein the aggregated data may indicate quantities of sent and received packets in association with different multicast groups, the container group members of each of the multicast groups, or some aggregated information for the multicast communications for the computing network. After aggregation, a summary can be generated based on the aggregated multicast statistical information. In some examples, the summary can be generated per a request from an administrator of the computing network. In other examples, the responds can be generated when the aggregated statistics satisfy one or more criteria.

As one example of generating a summary, an administrator of a computing network can request a list of container groups that have registered in association with a multicast group (i.e., registered to receive packets in association with a multicast IP address). In response to the request summary module 622 will direct processing system 650 to identify a portion of the aggregated information associated with the request. The portion would include identifiers for the container groups across one or more nodes that joined the multicast group. In some examples, each of the nodes can update a record that indicates multicast group associations for each of the container groups on the node. For example, a container group may register with a first multicast group, however, either expressly or via an expiration of the registration, the container group will no longer be registered with the multicast group. Accordingly, each node can provide an updated registration record (i.e., current registration information for the container groups) to computing system 600.

As another example of generating a summary, an administrator of a computing network can request the quantity of multicast packets received by container groups associated with a multicast group. In response to the request, summary module 622 directs processing system 650 to indicate the quantity of packets received in association with the multicast group based on the aggregated statistics. The information can be provided as part of a command line, a graph, a table, or some other data structure.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
in a management service, receiving multicast statistical information from nodes in a computing environment, wherein the multicast statistical information comprises quantities of ingress and egress multicast packets associated with container groups executing on the nodes collected from monitoring network traffic at the nodes;
in the management service, aggregating the multicast statistical information from the nodes; and
in the management service and in response to a summary request, generating a summary for display based on the aggregated multicast statistical information.

2. The method of claim 1, wherein the nodes comprise physical computers or virtual machines.

3. The method of claim 1, wherein the summary request indicates a multicast group comprising a set of container groups from the container groups, and wherein the summary indicates a quantity of packets received by the multicast group with a multicast IP address associated with the multicast group.

4. The method of claim 1 further comprising:
in a first node of the nodes, monitoring the network traffic associated with one or more container groups of the container groups on the first node;
in the first node, identifying one or more multicast packets in the network traffic associated with the one or more container groups;
in the first node, identifying multicast statistical information for the first node based on the identified one or more multicast packets; and
in the first node, communicating the multicast statistical information for the first node to the management service.

5. The method of claim 4, wherein the one or more multicast packets comprise one or more ingress multicast packets directed to the one or more container groups, or one or more egress packets communicated from the one or more container groups.

6. The method of claim 1, wherein the quantities of ingress and egress multicast packets associated with the container groups on the nodes comprises quantities of permitted or dropped multicast packets associated with the container groups on the nodes.

7. The method of claim 1, wherein the multicast statistical information comprises identifiers for one or more container groups of the container groups registered in association with each multicast group of a plurality of multicast groups.

8. The method of claim 7, wherein the summary indicates, for at least one multicast group of the multicast groups, the one or more container groups associated the at least one multicast group.

9. A system comprising:
a plurality of nodes; and
a management service computing system configured to:
receive multicast statistical information from nodes in a computing environment, wherein the multicast statistical information comprises quantities of ingress and egress multicast packets associated with container groups executing on the nodes collected from monitoring network traffic at the nodes;
aggregate the multicast statistical information from the nodes; and
in response to a summary request, generate a summary for display based on the aggregated multicast statistical information.

10. The system of claim 9, wherein the plurality of nodes comprises a plurality of physical computers or a plurality of virtual machines executing on one or more physical computers.

11. The system of claim 9, wherein the summary request indicates a multicast group comprising a set of container groups from the container groups, and wherein the summary indicates a quantity of packets received by the multicast group with a multicast IP address associated with the multicast group.

12. The system of claim 9, wherein a first node of the plurality of nodes is configured to:
monitor the network traffic associated with one or more container groups of the container groups on the first node;
identify one or more multicast packets in the network traffic associated with the one or more container groups;
identify multicast statistical information for the first node based on the identified one or more multicast packets; and
communicate the multicast statistical information for the first node to the management service.

13. The system of claim 12, wherein the one or more multicast packets comprise one or more ingress multicast packets directed to the one or more container groups, or one or more egress packets communicated from the one or more container groups.

14. The system of claim 9, wherein the quantities of ingress and egress multicast packets associated with the container groups on the nodes comprises quantities of permitted or dropped multicast packets associated with the container groups on the nodes.

15. The system of claim 9, wherein the multicast statistical information comprises identifiers for one or more container groups of the container groups registered in association with each multicast group of a plurality of multicast groups.

16. The system of claim 9, wherein the summary indicates, for at least one multicast group of the multicast groups, the one or more container groups associated the at least one multicast group.

17. A method comprising:
in nodes of a computing network, monitoring network traffic associated with a plurality of container groups to identify multicast statistical information, wherein the multicast statistical information comprises identifiers for one or more container groups of the plurality of container groups registered via Internet Group Management Protocol (IGMP) packets or Multicast Listener Discovery (MLD) packets in association with each multicast group of a plurality of multicast groups;
in the nodes, communicating the multicast statistical information to a management service in the management service, receiving the multicast statistical information from the nodes;
in the management service, aggregating the multicast statistical information from the nodes; and
in the management service and in response to a summary request, generating a summary for display based on the aggregated multicast statistical information, wherein the summary indicates, for at least one multicast group of the plurality of multicast groups, the one or more container groups associated the at least one multicast group.

18. The method of claim 17, wherein the plurality of nodes comprises a plurality of physical computers or a plurality of virtual machines executing on one or more physical computers.

19. The method of claim 17, wherein the multicast statistical information comprises quantities of ingress and egress multicast packets associated with the plurality of container groups on the nodes.

20. The method of claim 19, wherein the summary request indicates a multicast group of the plurality of multicast groups, and wherein the summary indicates a quantity of packets received by the multicast group with a multicast IP address associated with the multicast group.
